(19) United States
(12) Patent Application Publication
(10) Pub. No.: US 2007/0297341 A1
(43) Pub. Date: Dec. 27, 2007

(54) Data transmission system and method

(75) Inventors: Chaucer Chiu, Taipei (TW); Lu Sun, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/521,985

(22) Filed: Sep. 14, 2006

(30) Foreign Application Priority Data
Jun. 23, 2006 (TW) 095122666

(51) Int. Cl. H04J 1/16

(52) U.S. Cl. 370/252; 370/465

(57) ABSTRACT

A data transmission system and method is disclosed, which is applicable to a network system having a server end and a plurality of user ends that connect with the server end and with one another. By categorizing the user ends into a high speed group and a low speed group based on a first speed standard, detecting maximum data transmission speeds between the user ends, and selecting appropriate user ends categorized into the high speed group to process data transmission with the user ends in the low speed group, the data transmission system and method of the present invention provides a technique which can take the full advantage of the redundancy of data transmission speed of user ends and increase the efficiency of transmitting data speed.

### BACKGROUND OF THE INVENTION

1. Field of the Invention

This invention relates to a data transmission system and a data transmission method, and more particularly, to a data transmission system and method applicable in a network system, which comprises a server end and a plurality of user ends that connect with the server end and with one another.

2. Description of Related Art

Ordinarily, a network system consists of a server end and a plurality of user ends, which are connected to the server end. The data transmission speed in the network system slows down easily due to network jam or other factors (such as inter-networks). This problem is more obviously in an Internet game, for in an Internet game the game player must exchange data, such as scenes, characters, upgrade, magic and items with the server end immediately. In this situation, the user ends have to transmit tremendous amount of data at one time. Besides, when there are a great number of Internet game players playing at the same time, the traffic jam in the network system will only get worse.

For instance, when an Internet game is being played, there are player A and player B at the same time, and the maximum transmission speed between play A and the server end is only 6 K/S due to network jam or other factors (e.g. inter-networks). This speed is far behind the demanded speed of transmitting the vast amount of data; Meanwhile, the maximum transmission speed between player B and the server end is 250 K/S, while play B needs only a speed of 15 K/S to transmit data to server end. There is a redundancy of 235 K/S between player B and server end. Besides, if the transmission speed between player A and player B is 244 K/S, and there is no actual data transmission between both players, it is a great waste of the transmission speed between both players.

As mentioned above, it is wasteful of the transmission speed between player B and server end, and between both players as well. Due to the low transmission speed between player A and server end, it takes a long time for player A to wait for server end to transmit data, for this, player A loses a great deal of interest to play Internet game.

Meanwhile, when an Internet game is being played, the data transmission between game players and the server end is processed by a single and complete package of data. In this situation, it is very easy for the outsiders to get acquisition or decode the transmitting data, and the security of data transmission is comparatively dropped.

Hence, it is a highly urgent issue in the industry for how to provide a technique which can take the full advantage of the redundancy data transmission speed of user ends, increase the efficiency of transmitting data from the server end to user ends, and enhance the security of data transmission.

### SUMMARY OF THE INVENTION

In views of the above-mentioned shortcomings of the prior art, it is a primary objective of the present invention to provide a data transmission system and method which enhances the efficiency of data transmission speed between the server end and a plurality of user ends.

It is another objective of the present invention to provide a data transmission system and method to reduce the overload of the server end.

It is a further objective of the present invention to provide a data transmission system and method to enhance the security of data transmission.

To achieve the above-mentioned and other objectives, a data transmission system is provided according to the present invention. The system is applicable to a network system having a server end and a plurality of user ends that connect with the server end and with one another. The data transmission system is used for processing data transmission between the server end and user ends. The server end has a transceiver module for receiving and transmitting data. The data transmission system includes a plurality of repeater modules located in the user ends respectively for forwarding data; a user ends processing module for detecting a maximum data transmission speed between the user ends and the server end periodically, categorizing the user ends into a high speed group and a low speed group based on a first speed standard and the detected maximum data transmission speed between the user ends and the server end, and storing the categorizing result; the user ends processing module being further for detecting another maximum data transmission speed between the user ends categorized into the high speed group and user ends categorized into the low speed group, selecting at least one of the user ends categorized into the high speed group and connected with the user end categorized into the low speed group to transmit data with the low speed user end based on a second speed standard and the detected another maximum data transmission between the user ends in the high speed group and the user ends in the low speed group, and storing the selecting result; and a data transmission processing module for detecting whether an object user end, to which the server end is transmitting data, is in the low speed group or in the high speed group, and for transmitting the data to the object user end if the object user end is detected to be in the high speed group, or for transmitting the data to the object user end via the repeater module of the selected user ends categorized into the high speed group corresponding to the object user end based on the selecting result if the object user end is detected to be in the low speed group.

In the present invention, the user ends processing module defines a user end is in the high speed group or in the low speed group, based on the first speed standard and the detected maximum data transmission speed between the plurality of user ends and the server end, if the maximum data transmission speed between a user end and the server end is greater than or equal to the first speed standard, the user end is in the high speed group, otherwise, the user end is in the low speed group, or, if the maximum data transmission speed between a user end and the server end is higher than the previously fixed user end, the user end is in the high speed group, otherwise, it is in low speed group; the user end processing module selects the corresponding high speed user ends for a low speed user end; based on the second speed standard and the detected maximum data transmission speed between the user ends in the high speed group and user ends in the low speed group, within the high speed user ends connecting with a low speed user end, if the maximum data transmission speed between a high speed user end and the low speed user end is greater than or equal to the second speed standard, the high speed user end is selected to transmit data with the low speed user end, or, if the maximum data transmission speed between a high speed user end and the low speed user end is higher than the previously fixed user end, the high speed user end is selected to transmit data with the low speed user end.

In the present invention, the data transmission system further comprises a partition module, which divides the transmitting data into a plurality of sub-data only if: (1) the object user end, to which the server end is transmitting data, is in the low speed group, and (2) the user ends processing module selects more than one corresponding high speed user ends, which are connecting with the low speed user end, to transmit data with the object user end, the transceiver module transmits the plurality of sub-data to the object user end via the repeater module of selected high speed user ends. The data transmission system further comprises a recovery module installed in each of the plurality of user ends, the recovery module restores the server end's data from the plurality of sub-data derived from partition module.

The present invention provides a data transmission method, which is applicable to a network system, comprising: a server end and a plurality of user ends that connect with the server end and with one another; the data transmission method is used to process data transmission between the server end and the plurality of user ends, wherein, the server end has a transceiver module to receive/transfer data, the data transmission method comprises the following steps:

(1) detecting a maximum data transmission speed between the plurality of user ends and the server end regularly, and, based on the first speed standard and the detected maximum data transmission speed between the plurality of user ends and the server end, divide the plurality of user ends into a high speed group and a low speed group, store the result of dividing, next, detect a maximum data transmission speed between the user ends in the high speed group and user ends in the low speed group, and, based on the second speed standard and the detected maximum data transmission speed between the user ends in the high speed group and user ends in the low speed group, select at least one of the user ends in the high speed group, which are connecting to the low speed user end, to process data transmission with the low speed user end, store the result of selecting; and,

(2) detecting whether an object user end, to which the server end is transmitting data, is in the high speed group or in the low speed group; and, if the object user end is in the high speed group, the transceiver module transmit data to the object user end; otherwise, the object user end is in the low speed group, then, based on the stored result of selecting, the transceiver transmits data to the object user end via the repeater module of the selected high speed user end.

In the step (1) of the data transmission method of the present invention, based on the first speed standard and the detected maximum data transmission speed between the plurality of user ends and the server end, if the maximum data transmission speed between a user end and the server end is greater than or equal to the first speed standard, define the user end in the high speed group, otherwise, define the user end in the low speed group, or, if the maximum data transmission speed between a user end and the server end is higher than the previously fixed user end, define the user end in the high speed group, otherwise, define the user end in the low speed group; based on the second speed standard and the detected maximum data transmission speed between the user ends in the high speed group and user ends in the low speed group, select the corresponding high speed user ends for a low speed user end from the high speed user ends connecting with the low speed user end, if the maximum data transmission speed between a high speed user end and the low speed user end is greater than or equal to the second speed standard, the high speed user end is selected to transmit data with the low speed user end, or, if the maximum data transmission speed between a high speed user end and the low speed user end is higher than the previously fixed user end, the high speed user end is selected to transmit data with the low speed user end.

In the data transmission method of the present invention, if the object user end is in the low speed group and there are more than one high speed user ends are selected as the high speed user ends to transmit data with the object user end, divide the transmitting data into a plurality of sub-data, then, based on the result of selecting, the transceiver module transmits the plurality of sub-data to the object user end via the corresponding selected high speed user ends.

In the prior art, the user end receives the transmitted data only via the server end, without regarding of the maximum data transmission speed between the server end and the user end. This causes the overload of server end, and consequently, the network jamming. Compared with the prior art, the data transmission system and method of the present invention overcome the problems mentioned above. When the maximum data transmission speed between the server end and the object user end, to which the server end is transmitting data, is extremely low, the data is forwarded to the object user end via the high speed user end having redundancy of data transmission speed, thus, the efficiency of data transmission is comparatively enhanced. Besides, the data is divided before being transmitted, therefore, the present invention also provides higher security for data transmission.

### BRIEF DESCRIPTION OF DRAWINGS

The present invention can be more fully understood by reading the following detailed descriptions of the preferred embodiments, with reference made to the accompanying drawings, wherein:

FIG. 1 is a system structure diagram of an exemplary embodiment of a data transmission system according to the present invention;

FIG. 2 is a schematic block diagram of the data transmission system shown in FIG. 1; and

FIG. 3 is a flowchart of an exemplary embodiment of a data transmission method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

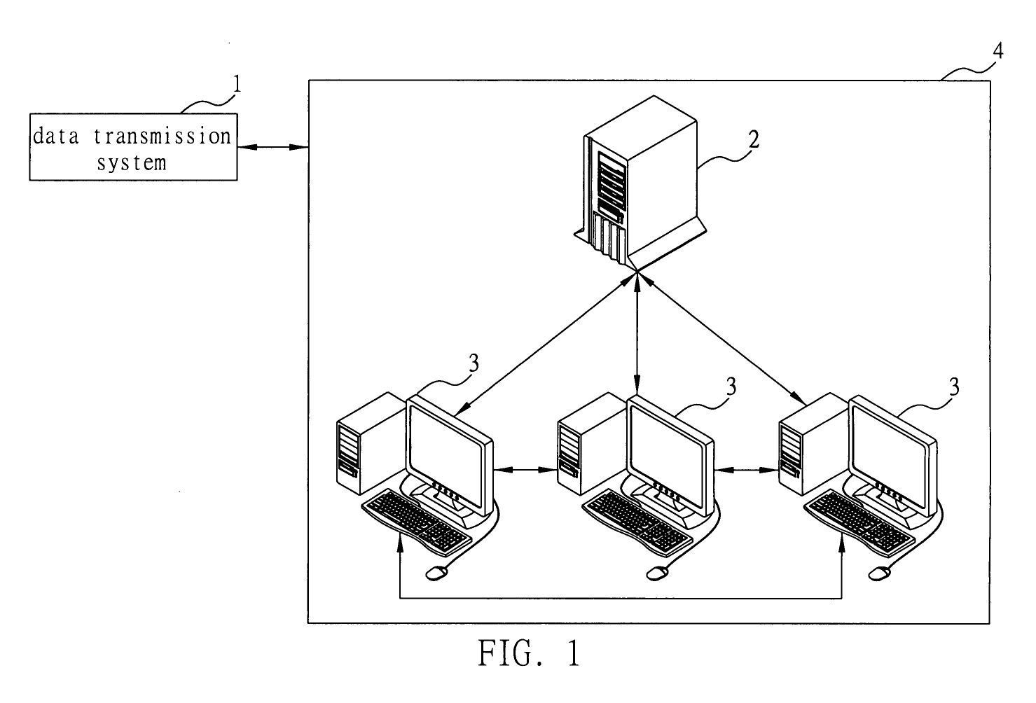

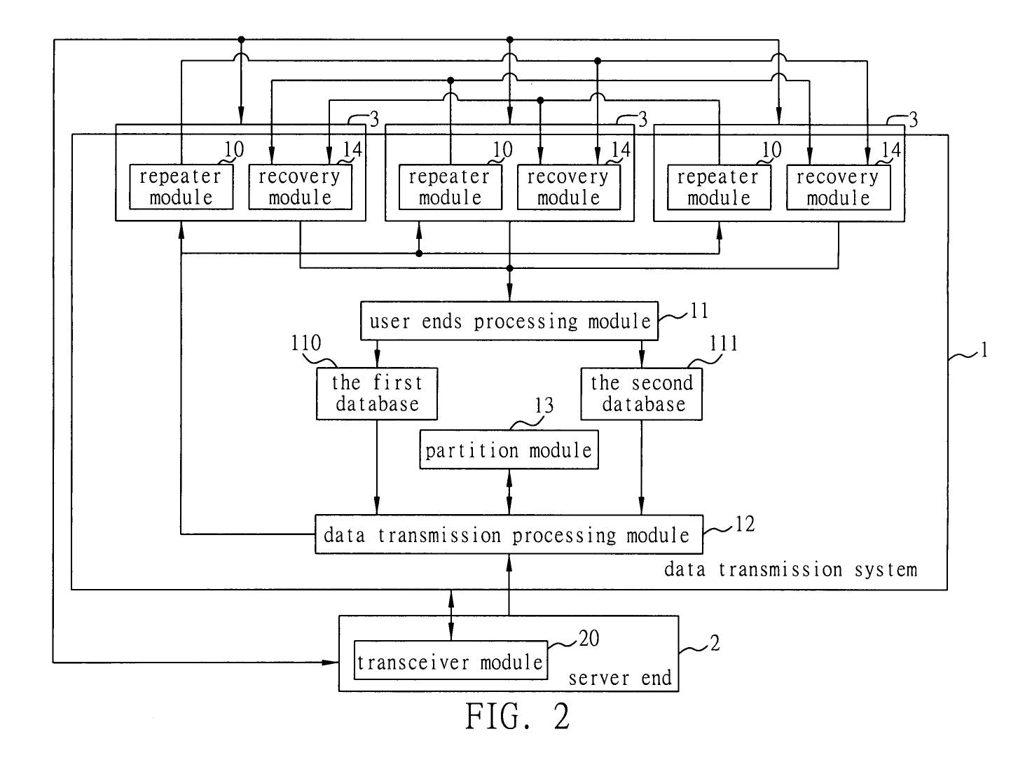

FIG. 1 is a system structure diagram of an exemplary embodiment of a data transmission system 1 according to the present invention, and FIG. 2 is a schematic block diagram of the data transmission system 1.

As illustrated in the figures, the data transmission system 1 of the present invention is: applicable to a network system 4 comprising a server end 2 and a plurality of user ends 3 that connect with the server end 2 and with one another. The data transmission system 1 processes data transmission between the server end 2 and the user ends 3. The server end 2 has a transceiver module 20 to receive/transfer data from/to the user ends 3. In the present exemplary embodiment, the server end 2 is a server, the user ends 2 comprise three computers. It should be understood that a number of the user ends is up to the demand of a real situation but not limited to the number used herein.

The data transmission system 1 comprises a plurality of repeater modules 10, a user ends processing module 11, a data transmission processing module 12, a partition module 13, and a plurality of recovery modules 14. Followed is the detailed description of the above-mentioned subject items in the data transmission system of the present invention.

The repeater modules 10 are located inside the user ends 3 respectively, and are used to forward data.

The user ends processing module 11 detects a maximum data transmission speed between the user ends 3 and the server end 2 periodically, and categorizes the user ends 3 into a high speed group and a low speed group based on a first speed standard and the detected maximum data transmission speed between the user ends 3 and the server end 2. The categorizing result is then stored in a first database 110. The user ends processing module 11 next detects another maximum data transmission speed between the user ends 3 categorized into the high speed group and the user ends 3 categorized into the low speed group, selects at least one of the user ends 3 categorized into the high speed and connected with the user ends 3 categorized into the low speed group based on a second speed standard and the detected another maximum data transmission speed, the selected user end 3 being used for exchanging data with the user ends 3 categorized into the low speed group, and stores the selecting result in a second database 111.

In the present exemplary embodiment, based on the first speed standard and the detected maximum data transmission speed between the plurality of user ends 3 and the server end 2, the user end processing module 11 defines whether a user end 3 is in the high speed group or in the low speed group, if the maximum data transmission speed between a user end 3 and the server end 2 is greater than or equal to the first speed standard, the user end 3 is in the high speed group, otherwise, it is in the low speed group; or, the maximum data transmission speed between a user end 3 and the server end 2 is higher than the previously fixed user end 3, the user end 3 is in the high speed group, otherwise, it is in the low speed group.

Next, based on the second speed standard and the detected another maximum data transmission speed between the user ends 3 in the high speed group and the user ends 3 in the low speed group, the user ends processing module 11 selects the user ends 3 in the high speed group connecting with the user ends 3 in the low speed group, to transmit data from server end 2 to the user ends 3 in the low speed group, only if (1) the another maximum data transmission speed between the user ends 3 in the high speed group and the user ends 3 in the low speed group is greater than or equal to the second speed standard, or (2) the another maximum data transmission speed between the user ends 3 in the high speed group and the user ends 3 in the low speed group is higher than the previously fixed user end.

The data transmission processing module 12 detects whether an object user end, to which the server end 2 is transmitting data, is categorized into the high speed group or into the low speed group, and the transceiver module 20 transmits data to the object user end if the object user end is detected to be categorized into the high speed group, or the transceiver module 20 transmits data to the object user end via the repeater module 10 of the selected user ends 3 in the high speed group corresponding to the object user end based on the selecting result stored in the second database 111.

When the object user end is detected to be in the low speed group and the user ends processing module 11 selects more than one user ends 3 from the high speed group, which are connected with the object user end to transmit data with the object user end, the partition module 13 divides the data into a plurality of sub-data. The transceiver module 20 transmits the sub-data to the object user end via the repeater module 10 of the corresponding selected high speed user ends based on the selecting result stored in second database 111.

The recovery modules 14 are installed in each of the user ends 3 respectively for restoring the data of server end 2 from the sub-data derived from the partition module 13.

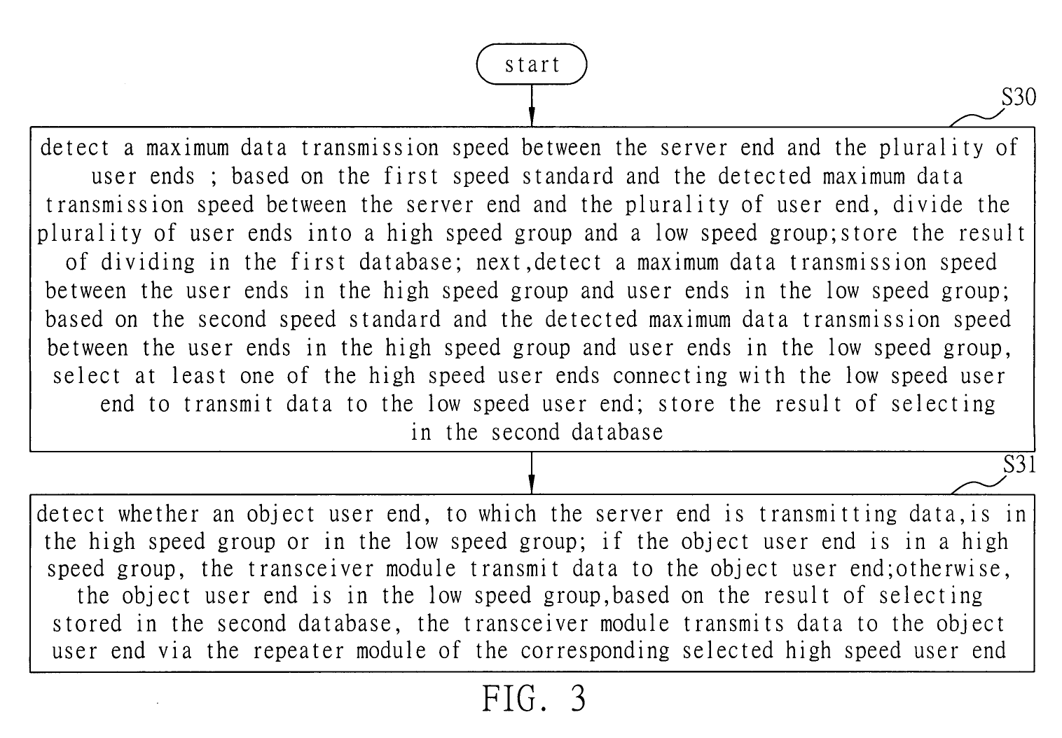

FIG. 3 is a flowchart illustrating the operational flow of the exemplary embodiment of a data transmission method according to the present invention. As illustrated, the method begins in step S30. In step S30, the method detects a maximum data transmission speed between the plurality of user ends and the server end regularly, then, based on the first speed standard and the detected maximum data transmission speed the plurality of user ends and the server end, divide the plurality of user ends into a high speed group and a low speed group, store the result of dividing in the first database; next, detect a maximum data transmission speed between the user ends in the high speed group and the user ends in the low speed group, then, based on the second speed standard and the detected maximum data transmission speed between the user ends in the high speed group and user ends in the low speed group, select at least one high speed user end connecting with the user end to process data transmission with the low speed user end, and, store the result of selecting in the second database.

In the present exemplary embodiment, based on the first speed standard and the detected maximum data transmission speed between the plurality of user ends and the server end, if the data transmission speed between a user end and the server end is greater than or equal to the first speed standard, define the user end in the high speed group, otherwise, define it in a low speed group; or, if the data transmission speed between a user end and the server end is higher than the previously fixed user end, define the user end in the high speed group, otherwise, define it in the low speed group; based on the second speed standard and the detected maximum transmission speed between the user ends in the high speed group and the user ends in the low speed group, if the data transmission speed between a high speed user end and a low speed user end is greater than or equal to the second speed standard, the high speed user end is selected to process data transmission with the low speed user end; or, if the maximum data transmission speed between a low speed user end and a high speed user end is higher than the previously fixed user end, the high speed user end is selected to process data transmission with the low speed user end. The method proceeds to step S31.

In step S31, the method detects whether an object user end, to which the server end is transmitting data, is in the high speed group or in the low speed group, and, if the object user end is in the high speed group, the transceiver module of the server end transmits data to the object user end; if the object user end is in the low speed group, based on the result of selecting stored in the second database, the transceiver module transmits data to the object user end via the repeater module of the corresponding selected high speed user end.

In the present exemplary embodiment, if the object user end is in the low speed group, and, more than one high speed user ends, which are connecting with the object user end, are selected to process data transmission with the object speed user end, divide the transmitting data into a plurality of sub-data; next, based on the result of selecting stored in the second database, the transceiver module transmits the plurality of sub-data to the object user end via the repeater module of corresponding selected high speed user ends; the recovery module of the object user end restores the data of server end from the plurality of sub-data derived from the partition module.

To further illustrate the principle and efficiency of the present invention, in the following exemplary embodiment, the server end 2 is the server of a network game, the plurality of user ends 3 is the computers A, B, and C of the game players'. First, detect a maximum data transmission speed between the server end 2 and computers A, B, and C, and the detected the maximum data transmission speed between the server end 2 and computers A, B, and C are, 200 K/S, 150 K/S and 15 K/S respectively, next, based on the first speed standard and the detected maximum data transmission speed between the server end 2 and computers A, B, and C (200 K/S, 150 K/S and 15 K/S), if the maximum data transmission speed between the server end 2 and the computers A, B, and C is greater than or equal to the first speed standard (e.g. 80 K/S), the computer is defined in the high speed group, otherwise, the computer is defined in the low speed group, in the present exemplary embodiment, computers A and B are defined in the high speed group, and the computer C is defined in the low speed group, the result of dividing is stored in the first database 110.

Next, detect a maximum data transmission speed between the user ends in the high speed group (e.g. computers A and B) and the user end in low speed group (e.g. computer C), the maximum data transmission speed between computer C and computers A and B are 120 K/S and 150 K/S respectively; and based on the second speed standard and the detected maximum data transmission speed (120 K/S and 150 K/S) between the high speed user ends (computers A and B) and the low speed user end (computer C), within the high speed user ends (computers A and B) connecting with the low speed user end (computer C), if the maximum data transmission speed between a high speed user end and a low speed user end is greater than or equal to the second speed standard (e.g. 100 K/S), the high speed user end is selected to transmit data with the low speed user end, in the present exemplary embodiment, both computers A and B are selected as the high speed user ends to transmit data with the low speed user end (computer C), the result of selecting is stored in the second database 111.

Next, detect whether an object user end, to which the server end 2 is transmitting data, is in a high speed group or in a low speed group, for instance, the object user end is computer C, and, it is in the low speed group and has more than one selected high speed user ends (computers A and B) to transmit data with; in this case, since more than one high speed user ends (computers A and B) are selected to process data transmission, first, divide the data into a plurality of sub-data, and based on the result of selecting stored in the second database 111, the transceiver 20 transmits the plurality of sub-data to the object user end (computer C) via the repeater module 10 of the selected high speed user ends (computers A and B), then, the recovery module 14 of the object user end (computer C) restores the data of server end 2 from the plurality of sub-data

In summary, the data transmission system and method of the present invention makes the use of a plurality of repeater modules, a user ends processing module, and a data transmission processing module; wherein, first, based on the maximum data transmission speed between the user ends, as well as between the user ends and the server end, divide and select the plurality of user ends; next, detect an object user end, to which the server end is transmitting data, then, transmit data to the object user end based on the results of dividing and selecting. Therefore, the present invention takes the full advantage of the redundancy of the data transmission speed of user ends, and enhances the efficiency and security of data transmission.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A data transmission system which is applicable to a network system comprising a server end and a plurality of user ends that connect with the server end and with one another, the data transmission system processing data transmission between the server end and the user ends, the server end having a transceiver module to receive/transfer data, the data transmission system comprising:
a plurality of repeater modules located in the user ends respectively for forwarding data;
a user ends processing module for detecting a maximum data transmission speed between the user ends and the server end periodically, categorizing the user ends into a high speed group and a low speed group based on a first speed standard and the detected maximum data transmission speed between the user ends and the server end, and storing the categorizing result; the user ends processing module being further for detecting another maximum data transmission speed between the user ends categorized into the high speed group and user ends categorized into the low speed group, selecting at least one of the user ends categorized into the high speed group and connected with the user end categorized into the low speed group to transmit data with the low speed user end based on a second speed standard and the detected another maximum data transmission between the user ends in the high speed group and the user ends in the low speed group, and storing the selecting result; and
a data transmission processing module for detecting whether an object user end, to which the server end is transmitting data, is in the low speed group or in the high speed group, and for transmitting the data to the object user end if the object user end is detected to be in the high speed group, or for transmitting the data to the object user end via the repeater module of the selected user ends categorized into the high speed group corresponding to the object user end based on the selecting result if the object user end is detected to be in the low speed group.

2. The data transmission system of claim 1, wherein, based on the first speed standard and the detected maximum data transmission speed between the plurality of user ends and the server end, the user ends processing module defines whether a user end is in the high speed group or in the low speed group, if the maximum data transmission speed between a user end and the server end is greater than or equal to the first speed standard, the user end is defined in the high speed group, otherwise, the user end is defined in the low speed group, or, if the maximum data transmission speed between a user end and the server end is higher than the previously fixed user end, the user end is defined in the high speed group, otherwise, it is defined in the low speed group.

3. The data transmission system of claim 1, wherein, based on the second speed standard and the detected maximum data transmission speed between the user ends in the high speed group and user ends in the low speed group, the user end processing module selects the corresponding high speed user ends for a low speed user end, within the high speed user ends connecting with a low speed user end, if the maximum data transmission speed between a high speed user end and the low speed user end is greater than or equal to the second speed standard, the high speed user end is selected to transmit data with the low speed user end, or, if the maximum data transmission speed between a high speed user end and the low speed user end is higher than the previously fixed user end, the high speed user end is selected to transmit data to the low speed user end.

4. The data transmission system of claim 1 further comprising a partition module, which divides the transmitting data into a plurality of sub-data only if: (1) the object user end, to which the server end is transmitting data, is in the low speed group, and (2) the user ends processing module selects more than one high speed user ends, which connect with the low speed user end, to transmit data with the object user end; after the partition, the transceiver module transmits the plurality of sub-data to the object user end via the repeater module of selected high speed user ends.

5. The data transmission system of claim 4 further comprising a plurality of recovery modules installed in the user ends respectively for recovering the data of server end from the sub-data.

6. A data transmission method, which is applicable to a network system comprising a server end and a plurality of user ends that connect with the server end and with one another; the data transmission method being used for processing data transmission between the server end and the user ends, the server end having a transceiver module to receive/transfer data, the data transmission method comprising:
(1) detecting a maximum data transmission speed between the user ends and the server end periodically, then, based on the first speed standard and the detected maximum data transmission speed between the plurality of user ends and the server end, divide the plurality of user ends into a high speed group and a low speed group, store the result of dividing; next, detect another maximum data transmission speed between the user ends in the high speed group and user ends in the low speed group, then, based on the second speed standard and the detected another maximum data transmission speed between the user ends in the high speed group and user ends in the low speed group, select at least one of the user ends in the high speed group, which are connecting to a low speed user end, to process data transmission with the low speed user end, store the result of selecting; and,
(2) detecting whether an object user end, to which the server end is transmitting data, is in the high speed group or in the low speed group, and, if the object user end is in the high speed group, the transceiver module transmits data to the object user end; otherwise, the object user end is in the low speed group, then, based on the stored result of selecting, the transceiver transmits data to the object user end via the corresponding selected high speed user end.

7. The data transmission method of claim 6, wherein, in step (1), based on the first speed standard and the detected maximum data transmission speed between the plurality of user ends and the server end, if the maximum data transmission speed between a user end and the server end is greater than or equal to the first speed standard, define the user end in the high speed group, otherwise, define the user end in the low speed group; or, if the maximum data transmission speed between a user end and the server end is higher than the previously fixed user end, define the user end in the high speed group, otherwise, define the user end in the low speed group.

8. The data transmission method of claim 6, wherein, in step (1), based on the second speed standard and the detected maximum data transmission speed between the user ends in the high speed group and user ends in the low speed group, select the corresponding high speed user ends to process data transmission with a low speed user end from the high speed user ends connecting with the low speed user end: if the maximum data transmission speed between a high speed user end and the low speed user end is greater than or equal to the second speed standard, the high speed user end is selected to transmit data with the low speed user end; or, if the maximum data transmission speed between a high speed user end and the low speed user end is higher than the previously fixed user end, the high speed user end is selected to transmit data with the low speed user end.

9. The data transmission method of claim 6, wherein, if the object user end is in the low speed group and there are more than one high speed user ends selected as the high speed user ends to transmit data with the object user end, divide the transmitting data into a plurality of sub-data; then, based on the result of selecting, the transceiver module transmits the plurality of sub-data to the object user end via the corresponding selected high speed user ends.

10. The data transmission method of claim 9 further comprising restoring the server end's data from the plurality of sub-data.
